(19) United States
(12) Patent Application Publication
(10) Pub. No.: US 2018/0007345 A1
(43) Pub. Date: Jan. 4, 2018

(54) SELF-RECTIFICATION OF STEREO CAMERA

(71) Applicant: IMRA Europe S.A.S., Sophia-Antipolis (FR)

(72) Inventor: Sylvain BOUGNOUX, Vallauris (FR)

(21) Appl. No.: 15/539,984

(22) PCT Filed: Jan. 18, 2016
(86) PCT No.: PCT/EP2016/050916

§ 371 Date: Jun. 26, 2017

(30) Foreign Application Priority Data
Jan. 16, 2015 (DE) 10 2015 000 250.3

(51) Int. Cl. H04N 13/02; G06T 7/60; G06T 7/80; G06T 7/73; H04N 13/00; B60R 1/00

(52) U.S. Cl. CPC H04N 13/0246; G06T 7/85; G06T 7/74; H04N 13/0239; H04N 13/0296; G06T 7/60; B60R 1/00; B60R 2300/107; B60R 2300/303; G06T 2207/20021; G06T 2207/20072; H04N 2013/0081; G06T 2207/10012

(57) ABSTRACT

Embodiments include a method for self-rectification of a stereo camera, wherein the stereo camera comprises a first camera and a second camera, the method comprises creating image pairs from a first images taken by the first camera and second images taken by the second camera, respectively, such that each image pair comprises two images taken at essentially the same time by the first camera and the second camera, respectively. The method comprises creating, for each image pair, matching point pairs from corresponding points in the two images of each image pair, such that each matching point pair comprises one point from each of the first and second image of the respective image pair. For each matching point pair, a disparity is calculated and a plurality of disparities is created for each image pair, and the resulting plurality of disparities is taken into account for the self-rectification.

### CROSS REFERENCE TO RELATED APPLICATIONS

This application is a National Phase filing under 35 C.F.R. §371 of and claims priority to PCT Application No.: PCT/EP2016/050916, filed on Jan. 18, 2016, which claims the priority benefit under 35 U.S.C. §119 of German Application No.: 10 2015 000 250.3, filed on Jan. 16, 2015, the contents of which are hereby incorporated in their entireties by reference.

### BACKGROUND

Some embodiments relate to a method for self-rectification of a stereo camera as well as to a device configured to carry out such a method and a vehicle comprising such a device.

In the following, the expression “the recovery” relates to an estimation of the parameters of a selected model of rectification. The rectification is equivalent to recovering the relative pose P, defined as

P=[R t],

wherein R is a rotation and t is a position component, coding a relative pose between two cameras. P is a 3×4 matrix. H∞ stands for the homography of a plane at infinity. The parameter fB is the product of the focal length of the rectified image and the baseline (the distance between the two cameras). Furthermore, it is referred to as the pan (or pan angle) for the horizontal angles between two optical axes; this angle is also known as the yaw; this measure is sometimes referred to the vergence angle of the stereo camera system.

One typical field of application for stereo cameras is the automotive field and in particular motor vehicles such as cars. It is highly advantageous if such stereo cameras are able to carry out some sort self-rectification in order to assure proper functioning of the stereo camera. Stereo cameras in vehicles are typically mounted on vehicles by means of so called stereo-rigs. Self-rectification is typically made for recovering the calibration/geometry of a stereo-rig from what it observes in natural conditions. The recovery may be needed for direct estimation (i.e. after factory assembly) or because the calibration has diverged from factory due to imponderable factors such as shocks or temperature.

However, self-rectification is reputed difficult and many car manufacturers either stopped using stereo-vision due to the de-calibration issue and the difficulty to recover the calibration (that is, to carry out self-rectification in a reliable way) or manufactured a robust camera frame increasing drastically the cost of the system. There are certain proposals in the literature for self-rectification, but none of them is satisfactory enough to reach a self-rectification robustly.

For example, DE10 2008 008 619 A1 presents a method for calibrating a stereo camera system in a vehicle. However, it limits the model to three parameters. The pan is estimated using a known distance. However in every day drive situations, it is impossible to rely on this knowledge, limiting the span of the disclosed subject matter. It could be by seeking an element of the car (e.g. at the end of the hood) but it leads to a too small distance for accurate computation.

US 2012 242806 A1 describes a stereo camera calibration system and proposes to simply correct the rectification via vertical and horizontal shifts. It is good as a rough estimation. However it is not accurate enough and does not cope with all types of de-calibration.

EP2 026 589 A1 discloses an online calibration of stereo camera systems including fine vergence movements. It proposes fine vergence correction, but uses actuators on the stereo camera, which limits the span of the disclosed subject matter and complicates the rectification process.

As mentioned above, the self-rectification methods for stereo camera systems known in the art have several shortcomings. In particular, they are not very reliable and their implementation in vehicles is expensive. Thus an aspect of the disclosed subject matter is to provide a self-rectification method for stereo camera systems that is reliable, precise and less expensive to implement in vehicles.

### SUMMARY

This problem is solved by a method for self-rectification of a stereo camera, wherein the stereo camera comprises a first camera and a second camera, wherein the method comprises creating a plurality of image pairs from a plurality of first images taken by the first camera and a plurality of second images taken by the second camera, respectively, such that each image pair comprises two images taken at essentially the same time by the first camera and the second camera, respectively. The expression “at essentially the same time” is to be understood in such a way that each image pair comprises one picture taken by the first camera and one picture taken by the second camera, wherein the first camera and the second camera are synchronized such as to take the two images at the same time, wherein a certain synchronization cannot be excluded and is acceptable to a certain extent. This method for self-rectification further comprises creating, for each image pair, a plurality of matching point pairs from corresponding points in the two images of each image pair, such that each matching point pair comprises one point from the first image of the respective image pair and one point from the second image of the respective image pair. In other words, corresponding points in the two images of each image pair are matched in order to create a certain number of matching point pairs for each image pair. In this regard, the expression “point” can relate to a subpixel or a pixel. In this method for self-rectification, a disparity is calculated for each matching point pair such that a plurality of disparities is created for each image pair, and the resulting plurality of disparities is taken into account for said self-rectification. Therein, the expression “disparity” is to be understood as the relative horizontal offset between the two points of a particular matching point pair measured in pixels. It is advantageous to carry out a rectification of the points forming part of the matching point pairs before calculating the disparities. Such a rectification is a classical process equivalent to turn both images fronto-parallel and vertically aligned, by applying to each image a specific homography derived from the relative pose P. Given this rectification, the expression “disparity” is to be understood as the relative horizontal offset (left-right) between the two points of a particular matching point pair measured in pixels in the rectified images, wherein “left” refers to a leftmost camera of the stereo camera system and “right” refers to a rightmost camera of the stereo camera system. In other words, the left camera typically corresponds to a left eye and the right camera typically corresponds to a right eye. For example, when looking in the forward driving direction of a vehicle on which the stereo camera system is installed such that the two cameras are horizontally aligned, the leftmost camera can be referred to as the left camera and the rightmost camera can be referred to as the right camera.

Some embodiments are based on the understanding that the currently available self-rectification methods for stereo cameras are unable to properly distinguish between scenes at infinity, also referred to as far scenes, (that is, for example landscape scenes with visible horizon) and close scenes (that is, scenes comprising a close object such as a vehicle driving in front of the vehicle on which the stereo camera system is installed), that these available self-rectification methods for stereo cameras are furthermore unable to properly estimate the pan, that the currently available self-rectification methods present numerical issues in the estimation of the relevant parameters for self-rectification and that all these issues can better be dealt with by calculating said disparities and by taking the resulting plurality of disparities into account in the self-rectification method. Typically, at least 100, preferably at least 200, more preferably at least 500 matching point pairs are created for each image pairs. Typically, at least 100, preferably at least 200, more preferably at least 500 image pairs are created during the method.

In one embodiment, for each image pair, a disparity histogram is created from said plurality of disparities, and said self-rectification is based on this disparity histogram. In this way, for each image pair, a histogram is created, typically with disparity values on the x-axis and magnitudes of each disparity value on the y-axis. The advantage of using such a disparity histogram is that the plurality of disparities are for each image pair sorted in a standardized and structured manner which improves the efficiency and reliability of the self-rectification method. However, the use of a histogram is not mandatory. It would also be possible to analyze the plurality of disparities for each image pair differently, for example by directly applying statistical methods.

In another embodiment, for each image pair, it is determined whether the corresponding disparity histogram comprises a relevant peak at a negative disparity value, wherein also a relevant peak at a slightly positive disparity value is preferably interpreted as a peak at a negative disparity value. In this context, the expression “relevant peak” is to be understood as “a peak having a relative magnitude higher than the relative magnitudes of the others and/or having an absolute magnitude above a certain magnitude threshold>>. Preferably, in case of ambiguity, the left-most peak is chosen. Preferably, a peak having a magnitude that is at least 50%, preferably at least 75%, more preferably at least 100% higher than the magnitude of the peak with the second largest magnitude, in particular in a range of negative and or slightly positive disparity values, is considered a relevant peak. In this context, magnitude can also be referred to as the energy, e.g. characterized by the population of the peak, possibly weighted by a confidence taken on the matches. In this context, a slightly positive disparity value is typically a disparity value between 0 and 0.6 pixels, preferably between 0 and 0.4 pixels, more preferably between 0 and 0.2 pixels. It is, however, also possible to only interpret peaks at mathematically negative disparity values as peaks at negative disparity values. The determination of relevant peaks at negative and/or slightly positive disparity values is advantageous because the mathematical theory on which the self-rectification method is based does in principle not allow the occurrence of negative disparity values. In consequence, the presence of a relevant peak at a negative disparity value allows identifying issues and/or image pairs not suitable for being used in the self-rectification method without further treatment, in particular not directly suitable for estimating a correct pan angle. In other words: a peak at a negative disparity value signifies the presence of a certain error. A direct estimation of the pan can thus not be applied, but it is possible to correct the corresponding distinct pan value in order to make it possible to use it for estimating an overall pan angle. However, it is not absolutely mandatory to identify relevant peaks at negative disparity values. Alternatively it would also be possible to not take negative disparity values into account at all or to take all disparity values into account.

In another embodiment, the method comprises determining a distinct pan value for each image pair, resulting in a plurality of distinct pan values, the method comprises creating a plurality of corrected pan values from the plurality of distinct pan values, preferably by correcting certain distinct pan values and by not correcting the remaining distinct pan values, and the method comprises an estimation of an overall pan angle from said plurality of corrected pan values. In other words: from a certain amount of distinct pan values, a certain amount of corrected pan values is established, and from this amount of corrected pan values, an overall pan angle is estimated. This has the advantage of making the estimation of the overall pan angle statistically solid. However, it would theoretically also be possible to determine the overall pan angle from only one distinct pan value and/or one corrected pan value. Preferably, at least 10, more preferably at least 100, most preferably at least 500 distinct pan values are used for creating the plurality of corrected pan values and/or for estimating the overall pan angle. Preferably, the estimation of the overall pan angle is an ongoing process in the method and/or the overall pan angle is estimated over and over again and/or recurrently and/or in an essentially infinite loop.

In another embodiment, if a relevant peak at a negative disparity value has been detected, the distinct pan value of the corresponding image pair is corrected and/or if no relevant peak at a negative disparity value has been detected, the distinct pan value of the corresponding image pair is not corrected. A pan correction is mostly equivalent to a translation of the image. Therefore each distinct pan value can be corrected such that the peak of infinity is located on the 0 disparity. Such a correction of the distinct pan values of image pairs presenting relevant peaks at negative disparity values has the advantage of making the estimation of the pan more precise because erroneous data is eliminated and/or corrected. Preferably, a histogram of distinct pan values is created and/or used for correcting the distinct pan values and or for estimating the overall pan angle.

In another embodiment, a mathematical model used for carrying out the method is, for each image pair, chosen out of a group of possible models, wherein said plurality of disparities is taken into account, preferably wherein said disparity histogram is taken into account. Basing the choice of the model on the plurality of disparities and/or on the disparity histogram is advantageous because the disparity distribution of an image pair can be used to determine whether the image pair relates to a close scene or a far scene, and an appropriate model can thus be chosen for each scene type. It is, however, theoretically also possible to use one and the same model for every scene type and/or do not use an adaptive model, for example in cases where cameras with specific technical parameters and/or technically sophisticated cameras are used. Preferably, a model with three parameters is selected for a far scene and a model with five parameters is selected for a close scene.

In a further embodiment, a mathematical model comprising a position component is chosen from said group of models if said histogram comprises at least a certain amount of large disparities, and a mathematical model without a position component is chosen from said group of models if said histogram comprises less than said certain amount of large disparities. Preferably, said certain amount is at least 20%, preferably at least 30%, more preferably at least 50% of all disparities and/or at least 50, preferably at least 100, more preferably at least 200 disparities. Preferably, a disparity of a size of at least four pixels, preferably at least 6 pixels, more preferably at least ten pixels is considered a “large disparity”. Basing the choice of the model on the amount of large disparities is advantageous because an image showing a close scene typically comprises a comparably high amount of large disparities. However, it is also possible to choose the models differently and/or not to use an adaptive model at all.

In another embodiment, the method comprises determining a distinct tilt value for each image pair, resulting in a plurality of distinct tilt values, and the method further comprises an estimation of an overall tilt angle from said plurality of distinct tilt values. Preferably, the method further comprises determining a distinct roll value for each image pair, resulting in a plurality of distinct roll values and/or the method further comprises an estimation of an overall roll angle from said plurality of distinct roll values. Therein, the overall tilt angle is preferably estimated before the overall pan angle and/or before the overall roll angle is estimated, and the overall pan angle is preferably estimated before the overall roll angle is estimated. It is advantageous to determine first the overall tilt angle because its calculation is straightforward. It is advantageous to determine the overall pan angle before the overall roll angle, because a compensation of errors in the pan angle estimation is possible by taking into account the disparities, the overall pan angle can thus be estimated more reliably than the overall roll angle and determining the overall roll angle last can thus be imagined to introduce the smallest possible error. Preferably, the estimation of the overall tilt angle, the overall pan angle and/or the overall roll angle is an ongoing process in the method and/or the overall tilt angle, the overall pan angle and/or the overall roll angle is estimated over and over again and/or recurrently and/or in an essentially infinite loop.

In another embodiment, a compensation table is taken into account for said self-rectification, wherein the compensation table comprises a plurality of flow compensation values, wherein each flow compensation value indicates a flow compensation to potentially be applied to one point of each matching point pair. The compensation table typically reflects a systematical error of the stereo camera. A flow compensation value typically corresponds to a vertical offset of a particular point in an image, the offset being either positive or negative. The use of such a compensation table has the advantage that a systematical error that occurs during the rectification can be removed in a particularly simple and efficient way, thus improving the quality of the self-rectification.

In another embodiment, the flow compensation is only applied to one image of each image pair, preferably the right image of each image pair, wherein the flow compensation comprises the step of tessellating the image to which the flow compensation is to be applied as a grid, preferably a 16×12 grid, thus creating a plurality of buckets, preferably 192 buckets, thus making every point of the image to which the flow compensation is applied fall into one particular bucket, wherein each bucket corresponds to one flow compensation value of the compensation table, and the step of applying to each point in every bucket the flow compensation indicated by the corresponding flow compensation value. Carrying out the flow compensation in such a way is advantageous because it offers a good trade-off between rapidity and accuracy.

In another embodiment, the method comprises determining a distinct geometrical value for each image pair, wherein the distinct geometrical value is not a pan angle and not a roll angle and not a tilt angle, wherein the distinct geometrical value is preferably a translation value, resulting in a plurality of distinct geometrical values, preferably translation values, and the method comprises estimating an overall geometrical value, preferably an overall translation, from said plurality of distinct geometrical values. Preferably, the overall geometrical value is then used during the self-rectification. Working with geometrical values which are neither pans nor tilts nor rolls has the advantage of offering additional calibration possibilities in case a calibration based on pan correction and/or roll correction and/or tilt correction does not have the desired effect.

In another embodiment, the method comprises a procedure of creating the compensation table, wherein the procedure of creating the compensation table comprises a step of defining internal parameters of the stereo camera by means of a strong calibration procedure, in particular a calibration procedure that uses a 3D grid and/or a checkerboard, and preferably either a step of finding a reference pan angle and/or a reference geometrical value, preferably a translation, by using 3D reference distances, or a step of finding the reference pan angle and/or the reference geometrical value by applying any of the previously described steps for self-rectification, preferably any of the previously described steps for pan angle correction. Creating the compensation table in such a way has the advantage that it allows to choose the best available calibration for creating the compensation table. In this context, the term “checkerboard” refers to a calibration grid and the term “3D reference distances” refers to the usage of an object at a known distance from the apparatus. This known distance is then compared with the reconstructed one (from the stereo algorithm) and the calibration parameters are adjusted such that the reconstructed distance fits.

A device, in particular stereo camera system, according to the disclosed subject matter is configured to carry out a method according to the disclosed subject matter. Such a device typically comprises at least two cameras, a computing unit, a bus system, a fixing portion and/or a weatherproof housing.

A vehicle according to the disclosed subject matter comprises at least one device according to the disclosed subject matter.

A method for compensating systematical errors in a non-linear system according to the disclosed subject matter comprises a step of learning systematical residuals of the non-linear system and storing corresponding compensation values in a compensation table, and a step of using the compensation values to locally remove the systematical errors when estimating a solution of the non-linear system. In this context, the expression “learning systematical residuals” means that despite the usage of the best possible parameters of a model, at some points of the observation space, an objective function may measure a systematical residual. Therefore, it is possible to learn and remove this residual in order to avoid being spoiled by them.

In another embodiment, an observation space of the non-linear system is tessellated, preferably such that a plurality of buckets is created. Such a tessellation has the advantage to offer a systematical, standardized and efficient approach to carry out the compensation.

### FIGURES

In the following, the disclosed subject matter is described in detail by means of diagrams and drawings, wherein is shown:

FIG. 1: a drawing visualizing the parameters “tilt”, “pan” and “roll”,

FIG. 2a: a typical flow diagram for the pan;

FIG. 2b: a typical flow diagram for the tilt;

FIG. 2c: a typical flow diagram for the roll;

FIG. 3: a disparity histogram for a certain image pair;

FIG. 4a: a graph displaying distinct pan values for a plurality of image pairs;

FIG. 4b: a graph displaying a plurality of corrected pan values;

FIG. 5: a flow chart visualizing one typical embodiment of the method according to the disclosed subject matter, and

FIG. 6: a tessellated image to be used with the compensation table according to the disclosed subject matter.

### DESCRIPTION OF EMBODIMENTS

In a typical embodiment of the self-rectification method for a stereo camera system comprising two cameras, the internal parameters of the cameras are considered to be known and constant. In practice, this it is not completely true, but this assumption is sufficient for the needs of the disclosed subject matter. The reason for this is that adjusting the parameters of the relative pose P of the cameras can be considered to be sufficient for compensating small deviations of the internal parameters due to overfitting. The internal parameters include classical linear parameters such as focal length, aspect ratio, skew, principal points and the nonlinear distortion (whatever the selected model, e.g. radial, tangential, equidistant . . . ). The rectification of the stereo camera system depends on these parameters, and the relative pose P of the cameras. The exact way to perform the rectification is not made explicit here; there are many algorithms known in the art. But most of them are tributary of these coefficients or a recombination of them. It is convenient to use the essential matrix E:

E=t̂R,

which characterizes the essential geometry (which is the counterpart of the epipolar geometry in the Euclidean space), and wherein t represents a position component and R represents a rotation.

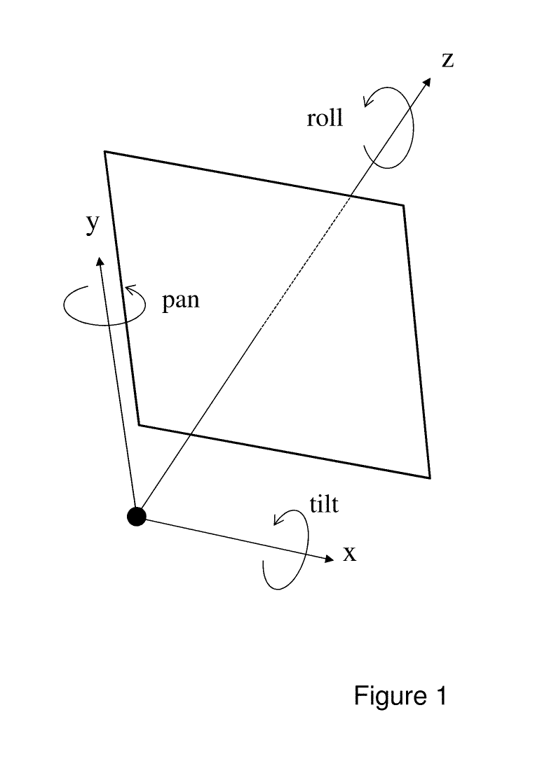

In order to properly understand how stereo cameras are typically rectified, it is first of all important to understand that three main parameters are present in stereo camera systems, namely the roll, the tilt and the pan. These parameters are visualized in FIG. 1.

FIG. 1 shows a model of the rotation R with 3 Euler's angles, as seen in the reference frame of the 1st camera where with classical notation for both cameras

P₀=[I₃ 0₃], and

P₁=P=[R t].

Therein, P₀ is a 3×4 matrix encoding the pose of the right camera, I₃ is the identity matrix in [symbol] ̂3, O₃ is the null vector in [symbol] ̂3, P₁ is a 3×4 matrix encoding the pose of the left camera in the reference frame of the right camera, the rotation R is a 3×3 matrix in O⁺( [symbol] ̂3) and the position component t is a vector in [symbol] ̂3.

Based on FIG. 1, the rotation R can be expressed as follows:

R=R(roll,z)*R(tilt,x)*R(pan,y),

wherein R(roll,z) is the rotation of the roll angle around the z axis, R(tilt,x) is the rotation of the tilt angle around the x axis and R(pan,y) is the rotation of the pan angle around the y axis.

As the norm of the position component t cannot be recovered by epipolar constraints (because it stands for the choice of the scale of the 3D reconstruction), two parameters describe the position component t, and globally five parameters describe any essential matrix E. The norm of the position component t is the baseline B; it is a supposedly fixed and known parameter.

The algorithm used in this embodiment consists in acquiring images from the stereo camera system; it extracts some points in each image and matches them, possibly collects them from frame to frame. Once enough matches have been collected and their 2D distribution is sufficient, these matches are sent to the Euclidean space based on the knowledge of the internal parameters, then the essential matrix E is estimated. Typically, the essential matrix E should satisfy the epipolar constraints

mᵢ₀^{t}Emᵢ₁=0,

with mᵢⱼ being the match i in respective image 0 or 1 expressed in projective coordinate, i.e. a vector of the form (x,y,1)̂t, (x,y) being the coordinate on the respective axis x and y.

from image 0 to image 1 for any match i; these constraints are typically minimized by means of the Sum of Square Residuals (SSR) method. This step

of the method includes a classical robust scheme to remove the outliers of the matches.

Until here, the algorithm used by the method is known in the art and can be regarded as classical. But the resulting essential matrix E is too noisy for accurate distance estimation. It has been found by the inventors that this noise is due to at least three sources of error:

1. The choice of the model: The disclosed subject matter is based on the understanding that the choice of an appropriate mathematical model is crucial in methods for self-rectification of stereo camera systems. However, the literature, e.g. in the automotive sector, mainly models only the rotation R, but not the position component t. The disclosed subject matter is furthermore based on the understanding that this is theoretically appropriate for scenes at infinity, that is far scenes, but that for closer scenes, e.g. when parking or when approaching another vehicle, the position component t is important (depending on the fB parameter—focal length, baseline) and neglecting it biases the recovery otherwise. When entering closer environment, e.g. statistically down-town or at home, the obtained rectification is not optimal and may cause an error in distance perception.

In other words: the model of the essential matrix E should be selected carefully. Indeed, whenever the matches are far, they provide constraints only useful to estimate the rotational component R of the essential matrix E and the position component t cannot be estimated, because any translation component cannot be estimated looking at infinity and t̂R is a solution for any position component t. Therefore the model should have three parameters (i. e. only the rotation R) or five parameters (i. e. the rotation R and the position component t) depending on the scene situation.

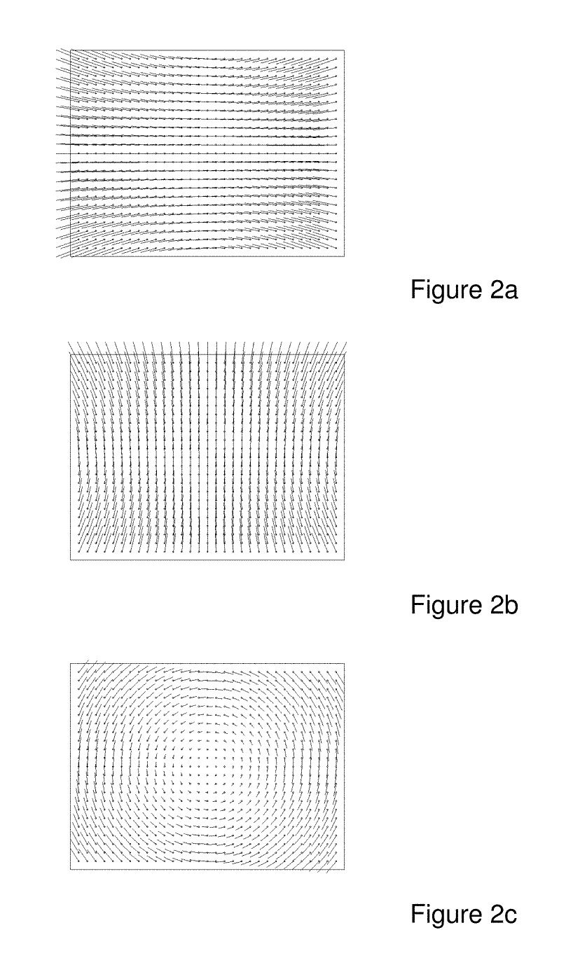

2. The difficulty to estimate the pan: this difficulty is due to the usage of the epipolar geometry (see below). The pan is important because it has a direct consequence on the estimation of the distances. In general this issue is not addressed by generic rectification method outside the automotive community (and sometimes even in this community as well). Indeed, at the 1st order, a modification of the pan does not violate the epipolar constraint, hence the difficulty. This can be observed in FIGS. 2a, 2b and 2c, which show flows of classic rotations, i.e. where the points (the small dots) of the image (the rectangle) go (the end of the given vectors) under a given rotation. The rotations are respectively a pan/tilt/roll of 0.1 rad in FIG. 2a/2b/2c. An error in the calibration creates a flow; the question is to know if this flow is observable using the epipolar residual. In FIG. 2a, the pan flows are mainly parallel to the rows of the image (i.e. to the epipolar lines of a rectified image pair, example in red); therefore, at 1st order, the flows don't violate the epipolar constraints. Reversely, for the tilt (in FIG. 2b), the flows are mostly vertical and therefore mostly orthogonal to epipolar lines, hence more easily observable. In FIG. 2c, for the roll, the flows are observable depending on the location (not in the y-top|bottom x-center areas where it is mostly horizontal, but in the x-leftlright y-center areas where it is mostly vertical). The literature imposes a view of the infinity, e.g. by running only on the highways, which allows seeing the rotation R as H∞. This transforms the epipolar constraint (point to line) as a homography constraint (point to point). But what happens when the horizon is occulted, e.g. by another car, is not clear. This issue strongly biases the known self-rectification methods.

In other words: the pan (also referred to as the vergence angle or the yaw) is difficult to get because a modification of the pan does not violate the epipolar constraints (see FIG. 2).

3.The numerical issues: Such issues arise in the estimation of the concerned parameters because all these parameters are not orthogonal (they influence each other) and because sometimes they are meaningless (overfitting issue). The literature doesn't propose a dedicated numerical scheme despite the minimization of a cost function (in general the root mean square (RMS) or equivalently an SSR) of the residuals of the epipolar constraints, or the residuals of Hoo, or the reprojection errors), or a Kalman Filter. In particular, the following types of numerical issues exist:
The epipolar constraint is the unique universal constraint, as it is not limited to rigid (static) or scene at infinity; therefore it is largely used. However it is not discriminative enough for fine pan estimation because at 1st order a pan perturbation does not violate the epipolar constraint of a rectified camera (horizontal displacement—rare vertical flow)—see FIG. 2.
The residuals of H∞ are limited to distant environment, e.g. on highways, or require a robust scheme to cull close/far environment especially that the frontier between close and far is not defined.
The reprojection errors (using a classical bundle adjustment technics) requires temporal matching, pose estimations and are complex, if not cumbersome, to settle. They add another important source of error and the quality of the matching depends on the environment. Therefore this technique is difficult to use in everyday situations.
The Kalman filter is not always pertinent, because neither the model nor the observations are linear, but also because the state belief is not Gaussian distributed; which are all theoretical prerequisites of such technique. Intuitively the biases (e.g. due to potentially wrong internal parameters and the matching outliers) corrupt the ability of the filter, especially because the various parameters are highly correlated.

The numerical scheme is a key-point as the pan cannot be recovered accurately. Therefore, as the parameters can easily compensate each other, the recovery may be trapped, and statistics such as RMS or flows are harder to interpret.

In other words: the numerical scheme should be adapted because the energy is flat and full of local minima because the parameters can compensate each other depending on biases in the matching, or on the hypothesis of known internal parameters.

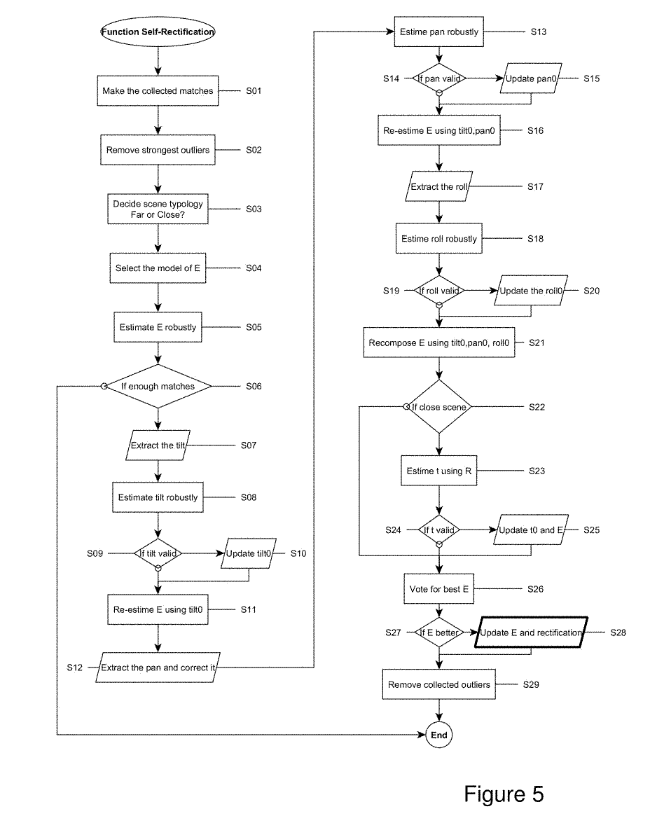

FIG. 5 gives an overview of an embodiment of the disclosed subject matter. It shows a flow chart visualizing one typical self-rectification method for a stereo camera system. The self-rectification function can be running continuously (e.g. by means of an infinite loop) in the stereo camera system or can be executed on demand or in certain intervals.

Once the self-rectification method has started, matching point pairs are created in step S01 based on respective corresponding points in an image taken by a first camera and an image taken by a second camera. These images are taken at essentially the same time by the two cameras and constitute an image pair. In step S02, the strongest outliers are removed from these matching point pairs.

In step S03, it is then decided whether the current scene, i.e. the scene corresponding to the current image pair, is a far scene or a close scene. This is done e.g. by calculating a disparity for each matching point pair, by creating a disparity histogram based on the calculated disparities, by deciding that the scene is a close scene if at least 50% of all disparities are larger than 10 pixels and by deciding that the scene is a far scene if less than 50% % of all disparities are larger than 10 pixels.

In step S04, a model of the essential matrix E is chosen, based on the decision made in step S03. In particular, a model with three parameters (i.e. only the rotation R) is chosen when dealing with a far scene and a model with five parameters (i.e the rotation R and the position component t) is chosen when dealing with a close scene.

In other words, in steps S03 and S04, the model is adapted to three or five parameters. When three parameters are selected, a position component t is, however, still needed. It is either possible to keep the current estimation (i.e. the estimation used in the previous iteration of the self-rectification method), or use an artificial one such as

t=sqrt(R)*(−B,0,0)^{t},

which has the ability to minimize image deformation when rectifying the images. The choice of the model depends on the distribution of the disparity (between left & right images). If this distribution contains enough large disparities, then the position component t must be included in the model, otherwise it must be removed. To do so, the population of large disparities is compared to a given threshold.

In step S05, the essential matrix E is then estimated robustly, which means that some outliers can again be detected and suppressed. In step S06, it is checked whether the number of matching point pairs of the current image pair is higher than a certain threshold. If there are not enough matches, the current iteration of the self-rectification function is stopped.

If there are enough matches, steps S07 to S29 are executed. As the tilt is the most stable parameter (because the generated flows are directly orthogonal to the epipolar lines—see FIG. 2), it is estimate first, namely in steps S07 to S08. To do so, the tilt is estimated for the current image pair (see step S07) and its estimation is accumulated from frame to frame and/or image pair to image pair into a histogram, see step S08. Whenever a peak appears in this histogram, that is if the validity test in step S09 is true, the value of this peak is accepted as the tilt estimation tilt0 in step S10. Otherwise, the current tilt estimation tilt0 is kept, that is, it is not updated. Then in cascade an estimation of the essential matrix E is re-computed with the given tilt (i.e. we have then 4 or 2 parameters depending on whether the position component t is used or not).

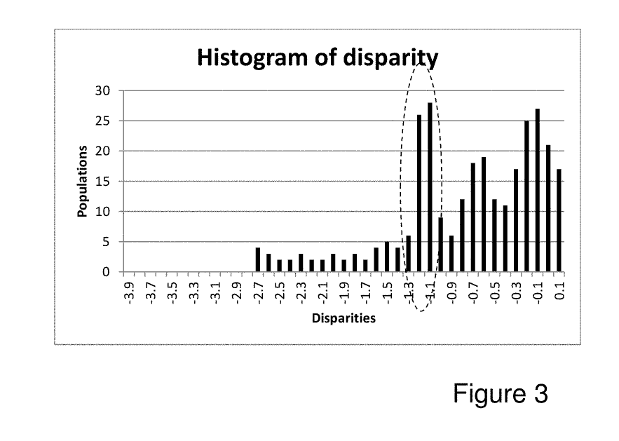

Then, the pan is estimated in steps S12 to S13. This is done in the following way: For the current essential matrix E, the distribution of the disparities of the matching point pairs is analyzed, in particular by means of a disparity histogram. FIG. 3 shows an example of such a disparity histogram. In particular, FIG. 3 shows an example of histogram of disparity around d=0 (x-axis is the disparity, y-axis is the population). There is a peak of population around d=−1.3, which is not acceptable. The population on the left of the peak is due to small error in the matching, the population on the right might be interpreted as the different objects of the scene. Indeed this population statistically reveals a peak around 0. Now the fact that for any disparity d we must have d≦0 is exploited. If the location of the peak is below 0 (i.e. on the negative side), then it is not acceptable, and the pan can be corrected such that this peak comes to 0. This can be done by translating the disparity, e.g. by adding an offset, which is equivalent to add an offset x_{offset} horizontally to the points of one image. As we are dealing with small angles, at 1^{st} order translating horizontally along x is equivalent to rotating vertically along y. Therefore, it is possible rather to correct the pan instead of the disparity. It is found with the focal length f:

Pan_{offset}≅x_{offset}/f,

wherein x_{offset} is the offset needed to translate the peak of infinity to 0, f is the focal length and pan_{offset} is the correction for adjusting the pan.

The previous pan estimation is then corrected using

pan_{new}→pan_{old}+pan_{offset},

wherein pan_{did} is the current estimation of the pan for this particular image pair and pan_{new} is the corrected pan, i.e. the one leading to a peak of disparity at 0.

By doing so, a benefic bias in the population of the estimated pans is introduced. For instance, if the pan was estimated uniformly around its true value, then this scheme will strongly reinforce the population of the good pans. It should also be noted that when the x_{offset}≧0, the scene can be interpreted as having a close object. In this situation the pan is not corrected, it is acceptable, though still an ambiguous situation exists (in the sense that the pan may remain inaccurate, but this remains unknown).

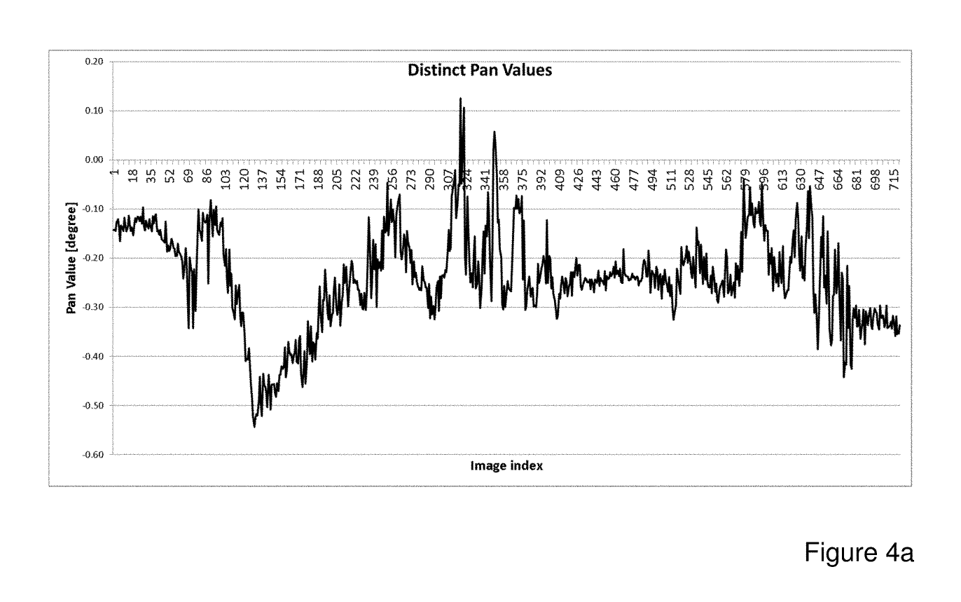

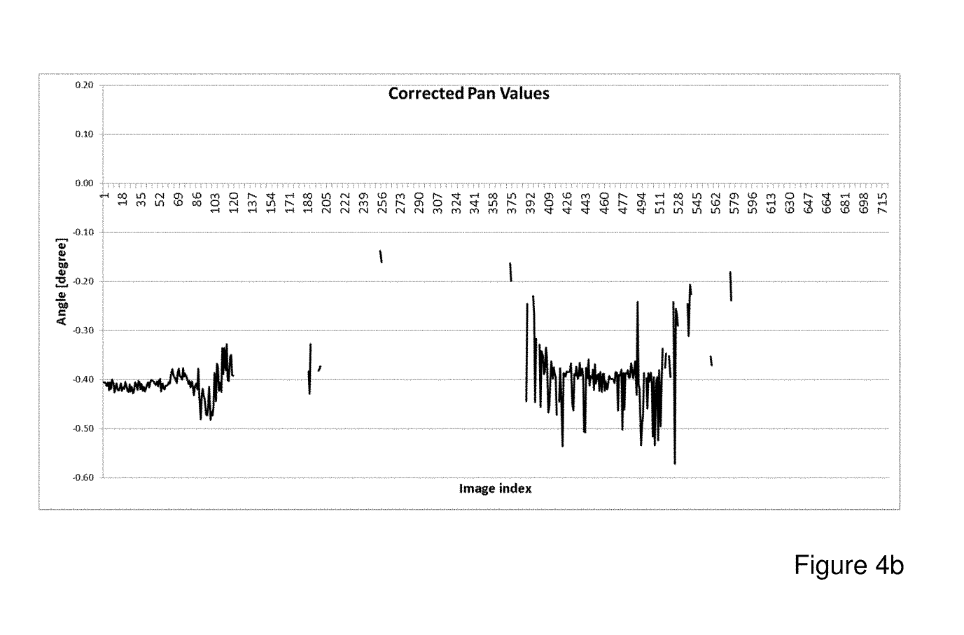

In other words, in step S12 a distinct pan value for the current image pair is determined. Because the function of FIG. 5 is repeated over and over again, a plurality of distinct pan values is thus created. Furthermore, from these distinct pan values (which are shown in FIG. 4a for different image pairs), a plurality of corrected pan values (which are shown in FIG. 4b) is created, preferably using the pan correction method outlined above. In order to carry out the correction, still in step S12, a disparity histogram as shown in FIG. 3 is created for the current image pair. If this disparity histogram shows a relevant peak at a negative disparity value (e.g. a value of −1.3 as shown in FIG. 3), then the distinct pan value of the current image pair is corrected, and this corrected distinct pan value is taken into account during the estimation of the overall pan angle, in particular by adding this corrected distinct pan value to the plurality of corrected pan values. In another embodiment, also peaks in the disparity histogram at slightly positive disparity values, for example disparity values of up to 0.5 pixels, are interpreted as peaks at negative disparity values.

In other words: also if, for a particular image pair, there is a peak at a slightly positive disparity value, it can be advantageous to undertake a correction of the corresponding distinct pan value and to add the resulting corrected pan value to the plurality of corrected pan values.

This way of estimating the pan is based on the understanding that the estimation of the pan is mostly instable. However statistically when driving, vehicles access locations with far visibility (but one cannot be aware of these situations, that is for example when they occur). In this spirit, it has been found that the population of the matching point pairs often accumulates at infinity (theoretically infinity is inaccessible, but numerically infinity, i.e. matches with very small disparity, is at 20, 50 or 100 m, depending on the fB parameter).

In step S13, from said plurality of corrected pan values, an overall pan angle is estimated. That is, similarly to the tilt estimation, the pan estimation is accumulated from frame to frame and/or image pair to image pair into a histogram. Whenever a peak appears in this histogram, that is if the validity test in step S14 is true, the value of this peak is accepted as the pan estimation pan0 in step S15. Otherwise, the current tilt estimation pan0 is kept, that is, it is not updated.

Then, in step S16, the essential matrix E is recomputed with the given tilt and pan for the roll, and the roll values are accumulated in a histogram (steps S17 and S18). When a peak appears, this value is accepted as an estimation of the roll (steps S19 and S20). At this stage, a new candidate for the rotation R has been obtained and the essential matrix E is recomposed in step S21. Then, in steps S22 to S25, a new position component t is estimated based on the rotation R, if necessary—that is, if the current scene has been classified as close scene in step S03—and if the found position component t is valid (see step S24), the currently used position component t0 and the currently used essential matrix are updated in step S25. The position component t is estimated e.g. by composing a linear system in the position component t from the epipolar constraints and using the known rotation R. The new (R,t) creates a new candidate essential matrix E. This new candidate essential matrix E is compared to the old essential matrix E (i.e. the current belief) in step S26. If statistically, e.g. by counting over successive frames, the new essential matrix E is better than the old one in term of epipolar residuals, then the new essential matrix E is adopted and become the current belief in steps S27 and S28. In step 29, collected outliers are removed from the possibly collected matches.

In the embodiment presented above, the problem is thus solved by using an adaptive model, and by evaluating the pan statistically, exploiting the constraint d≧0. Statistically means that the pan is not evaluated on each frame but on a series of frames as soon as enough far points can be observed. “Far” depends on the rig but can for example mean 20 m or 40 m. Furthermore, a numerical scheme is used, which evaluates the involved parameters hierarchically in cascade.

More precisely, an adaptive model that adjusts itself according to the scene and the specificities of the rig is used. The adaptive model selects automatically for each frame the optimum parameters depending on the situation. It is based on evaluating the distribution of the disparity. When the population of large disparities is strong enough, the position component t is added; otherwise it is removed and e.g. replaced by an artificial position component t.

Furthermore, a statistical solution to the estimation of the pan which is a major difficulty of all “epipolar methods”, especially for small baseline rigs, is used. It is done looking for the peak of the population of the disparity at infinity. By identifying this peak, it creates another estimation of the pan. Then exploiting the constraint d≧0 (the disparity is in theory always positive and negative values indicate possible errors) allows to statistically correct the estimation of the pan and introduce a benefic bias in the population of its estimation.

Furthermore, a coherent numerical scheme with hierarchic evaluations of the parameters is applied. The parameters do not play the same role, nor do they suffer from the same difficulties. One possibility is to estimate in cascade first the tilt, then the pan, then the roll, then possibly the position component t. At each step, a sufficient accumulation of coherent estimation must be collected. Eventually, the solution having statistically the best residual is kept.

In order to optimize de quality of the self-rectification according to the disclosed subject matter, it is furthermore possible to take into account a certain systematical error, which can be induced by a certain inadequacy of the applied model. In fact, the inventors have surprisingly found that it is under certain circumstances possible that, when the method described above is put into place, certain systematic vertical displacements or offsets between the two points of some matching point pairs can occur. The vertical displacements are also simply referred to as “flow” (whereas the horizontal offsets are referred to as “disparities”) and have a highly negative effect of the quality of the self-rectification. It is therefore desirable to remove these systematical flow errors.

In order to correct the systematical flow errors, a compensation table is established during the residual evaluation, i.e. the systematic errors of the system are learned and corresponding offset values, referred to as flow compensation values, are written into the compensation table. By compensating the systematical errors via the use of the flow compensation values, the SNR of the residuals is raised. Therefore the self-rectification is more stable.

The removing of the systematical errors by means of such a compensation table is described in more detail in the following.

The flow compensation is based on the idea that if most of the remaining vertical flows are locally systematic, it is possible to study them, in other words to “learn” them, and to then compensate any further estimations of the residuals.

First, the image in which the flow compensation is to be carried out is tessellated as a 16×12 grid. Each cell is called a bucket. This tessellation is only effective in the reference image (the right one); the disparity in the left image is considered as being in general small compared to the width of the bucket.

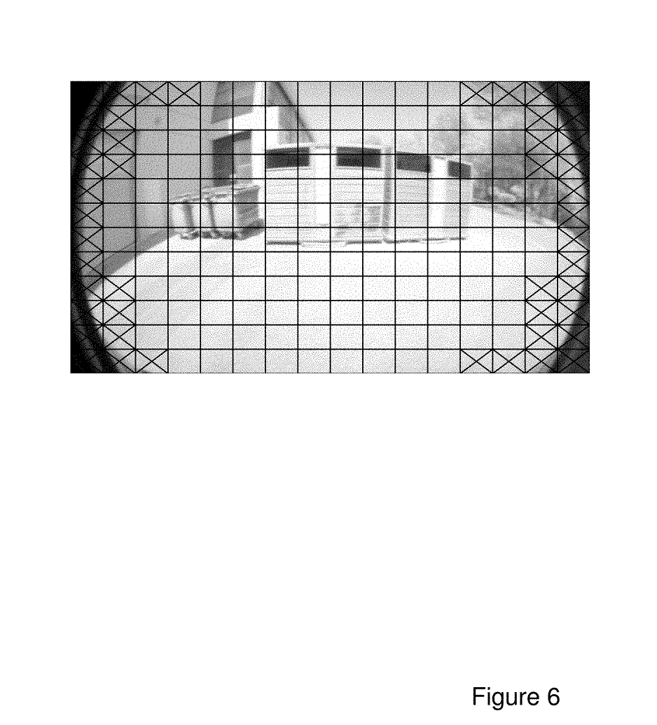

Therefore, as a first approximation, any matching point pair fall in the bucket defined by its right component in the right image. In each bucket, the matching point pairs (or the points of each matching point pair that correspond to the right image) of a full sequence are collected and the local residuals are studied. The median is taken as the local model of the residuals. If the standard deviation of the residuals is too strong or if the median is too different from the ones of its neighborhood, this bucket is skipped. Therefore, a trivial skip-table needs to be introduced, i.e. the identification of some buckets where any matches are rejected. This is visualized in FIG. 6, where an image that has read the skip-table is shown and buckets to be skipped are marked with a cross. Note that the skipped buckets fall on the far periphery where the image circle can be observed (in this case) maybe creating spurious points of interest. For the other buckets completely covered by the image, it is assumed that the quality of the projection model away from the center become crude. It is also imposed a central symmetry. Note that dealing with fish-eye lenses, the epipoles might be inside or close to the image and nearby points are sent during the rectification process toward infinity along the y-direction, turning their respective residuals or their y-flows unusable. Overall this explains their rejection.

Once the skip-table has been established, the compensation table itself is established, by memorizing the accepted median y-flow per bucket. Later, when any epipolar constraints are evaluated for estimating the essential geometry, the residuals are compensated by translating vertically every point with the related learned flow. It should be noted that at this stage the compensation table depends on the selected calibration.

By using the compensation table, the estimation of the pan (and the other angles) typically becomes more stable than without using it. It is difficult to measure stability quantitatively, e.g. because the standard deviation is not robust and is fooled by isolated strong errors.

However, the inventors have also observed incoherent pan₀ and pan_{∝}. Indeed a discrepancy of about 0.8° has been detected between these two pans after application of the compensation table. The question therefore naturally is: “Which one is correct?”

It makes sense to expect coherency. According to 3D distance, the pan_{∝} is correct. However according to the strong calibration procedure, the pan₀ is correct. As it is difficult to arbitrate, the following interpretation can be given.

It is difficult to tune a parameter such that the panₒ becomes the pan_{∝}. Reversely, it is easy to tune a parameter such that the distance is preserved and that the pan. becomes the pan₀. Indeed, so far the inventors had assumed, along with many others, that the internal parameters could be considered fixed and known. Many authors assume that to succeed in estimating the over-fitting epipolar system, one needs to reduce the system to the estimation of E, or in other words that E can cope with much of the deformations of the stereo-rig. It might be the case for some configurations, but not for the one that underlies the presently disclosed subject matter. Here, if one translates slightly one image horizontally, and modifies the pan in the opposite direction, these two deformations can be compensated at the 1st order. The principal points, especially the u₀ component (which corresponds to a horizontal translation of its image), seems a good candidate to cope with this deformation.

According to the perspective projection tan θ=x/f, hence at the 1st order for small angles, θ=x/f. Therefore if we modify u₀ with:

u₀′←u₀+fΔθ

then the pan₀ and the pan_{∝} become coherent and the 3D distance is preserved (here it is the u₀ of the left camera, and Δθ=θ_{∝}−θ₀, if one wants to change the u₀ of the right camera the sign has to be reversed). Indeed the pan₀ estimation is at first glance not really dependent on tiny horizontal translations of one image. Reversely the pan_{∝} is, because it depends directly on the observed disparities.

In fact if a thermal effect (e.g. as proposed in “Fiedler, D. & Muller, H. Impact of thermal and environmental conditions on the kinect sensor. LNCS 7854: 21-31, 2013”) is considered, a deformation of the u₀ is as likely to occur as a modification of the relative orientation, or even the focal length. Depending on the quality of the montage, any types of transformation can occur. When the image is translated by thermal deformation, and that this translation is better modeled by the u₀ parameter, if the peak of infinity is on the negative side, then tuning the rectification with E only might be sufficient (depending on the expected accuracy); however if the peak is on the positive side, it might be better to tune the u₀ instead. This illustrates the difficulty of the fine estimation of the rectification. The difficulty is in the selection of the parameters to balance between under/over-fitted systems. Note that this selection depends on the deformation and on the scene contents (e.g. the t cannot be estimated with far points).

As there are two u₀, namely one per image, one question is which one to move. As small transformations are being dealt with (here we are talking about a few tenths of pixels, and we are once again discussing an over-fitted problem), it is possible to move arbitrarily any of them; or the two with half of the needed transformation dispatched; or the one going toward the image center; or the further away, or any other.

As mentioned above, when the compensation table is learned, the selected calibration does count. As this table is introduced for estimating the calibration (or a part of it), we have a “chicken & egg” problem.

To cope with this issue, the following procedure for establishing the compensation table is used:

#1 Take the internal parameters as proposed by a strong calibration procedure, i.e. using a 3D grid/checkerboard.

#2 Find a pan_{ref} using 3D distances. It might not be the “right” pan, but it is the best estimation available at this stage.

#3 Make a moving sequence with a lot of matching point pairs, especially far ones (e.g. a few 100 k, that is e.g. 500000, matching point pairs).

#4 Estimate over the sequence the “best” parameters (pan, tilt, roll, & t), as well as the part, (wherein these parameters refer to the previously introduced parameters as described in FIG. 5). If the pan, is sufficiently clear, check that it is coherent with the pan_{ref}. If not, take the one you trust the most (depending on the various sources of errors from your experimental setup). Then evaluate the incoherence between the two pans Δθ and update the u₀ accordingly as explained above.

#5 Rectify all the matches with the identified calibration (updated u₀, “best” parameters).

#6 Learn the remaining flow as explained above.

#7 Just to check, relaunch the full estimation on the sequence using the compensation table. One should observe a stabilized pan.

#8 If the new stabilized pan estimation is too different from the pan used at #5, one can loop from stage #5 on the flow learning with this new pan, possibly new u₀.

As much as the above-mentioned tessellation is concerned, a regular 16×12 grid can be used, leading for a 720P resolution to 80×60 pixels per bucket. This grid should not be too fine to allow a statistical learning of the remaining flow. Meanwhile, the inventors have also observed with this specification a repetitive structure in the remaining flow (i.e. in the systematical error). Indeed per bucket can be observed a centrifugal distribution of the remaining flow sign (i. e. positive or negative). This repetitive structure witnesses that:
There is a global tendency/smoothness in the compensation table.
This 16×12 resolution is a bit crude to sample the compensation accurately.

The analysis has not be pushed further; if not optimum this resolution allows accurate enough pan estimations. Meanwhile, it has been noticed that this structure could help revealing a good pan. Indeed, an under-estimated pan created negative flow on the top-left corner, and positive flow on the top-right corner of the image; and reversely on the bottom line. Therefore, when this color pattern is horizontally balanced, a good pan can be expected. Furthermore, a second pattern in the systematical errors has been observed: When looking at a column of buckets on the image sides, one can observe 2 clusters (namely positive and negative flow populations) mostly separated by a straight line. If this line is bent to the left, the pan is under-estimated; reversely if this line is bent to the right, the pan is over-estimated. A vertical line assesses the good estimation of the pan. Of course it is a subjective and qualitative criterion but it has been found interesting in practice.

The inventors have furthermore found, that the underlying concept of the above-mentioned compensation table used during self-rectification of a stereo camera can be generalized.

As a matter of fact, the main idea of our method is to say that some portion of the residuals hides some of the relevant information. Indeed, residuals are due to noise in the observations (e.g. the matches), wrong parameter values (the ones of the system that the solver tunes, e.g. the E parameters), and wrong model selection (e.g. the choice of the internal parameters). In other words, when a wrong model is too much penalizing, the best solution is not at the minimum of the objective function (e.g. the RMS). The method proposed here reduces the importance of the question of the outliers, the chosen norm, the convergence, or the presence of local minimum, compared to the question of the model selection. The difficulties in solving such systems are rather due to a wrong choice of the model. However choosing a good model is difficult. There are typically some difficulties in using the AIC, especially when the question of under/over-fitting depends on the observations. A wrong choice of the model (in the present case the internal calibration model) creates too strong residuals influencing too much the solution. As this influence depends on the observations (e.g. the location of the matches), it is possible to observe an unstable solution (e.g. an unstable epipolar geometry). For instance, more matches on the top-left corner of the image compared to the top-right corner will tend depending on the model fidelity, to under/over-estimate the pan.

A generic solution consists in learning these systematic residuals and removing them locally in further estimations. This solution will always work when one can tessellate the observation space (as has been described above for the bucket grid) and can estimate statistically a systematic residual (as has been described above for the median). In this case one can learn locally this systematic residual and remove it locally during future estimations.

This also explains why some synthetic models work often much better than the real situations. Because in the synthetic models, one introduces rarely the residuals due to a wrong choice of the model. There is an SNR in the residuals; classically the observations introduce a random noise (e.g. white or Gaussian), but the error on the model introduce a systematic noise, biasing the solution. When the observations are moving, the biases are different leading to an unstable solution. By removing this systematic noise we simply raise the SNR of the residuals and obtain a more stable solution.

1-16. (canceled)

17. A method for self-rectification of a stereo camera, wherein:
a) the stereo camera includes a first camera and a second camera,
b) the method includes creating a plurality of image pairs from a plurality of first images taken by the first camera and a plurality of second images taken by the second camera, respectively, such that each image pair includes two images taken at essentially the same time by the first camera and the second camera, respectively,
c) the method includes creating, for each image pair, a plurality of matching point pairs from corresponding points in the two images of each image pair, such that each matching point pair includes one point from the first image of the respective image pair and one point from the second image of the respective image pair, and
d) for each matching point pair, a disparity is calculated such that a plurality of disparities is created for each image pair, and the resulting plurality of disparities is taken into account for said self-rectification, wherein:
for each image pair, a disparity histogram is created from said plurality of disparities, and said self-rectification is based on this disparity histogram,
in that, for each image pair, it is determined whether the corresponding disparity histogram includes a relevant peak at a negative disparity value, relevant peak being a peak having a relative magnitude higher than the relative magnitudes of other peaks and/or having an absolute magnitude above a certain magnitude threshold wherein also a relevant peak at a slightly positive disparity value is preferably interpreted as a peak at a negative disparity value, in that
i. the method includes determining a pan value for each image pair, resulting in a plurality of determined pan values,
ii. the method includes creating a plurality of corrected pan values from the plurality of determined pan values, preferably by correcting certain determined pan values and by not correcting the remaining determined pan values, and
iii. the method includes an estimation of an overall pan angle from said plurality of corrected pan values, and
in that if a relevant peak at a negative disparity value has been detected, the determined pan value of the corresponding image pair is corrected and/or if no relevant peak at a negative disparity value has been detected, the determined pan value of the corresponding image pair is not corrected.

18. The method according to claim 17, wherein a mathematical model used for carrying out the method is, for each image pair, chosen out of a group of possible models, wherein said plurality of disparities is taken into account, wherein said disparity histogram is taken into account.

19. The method according to claim 18, wherein:
a) a mathematical model including a position component is chosen from said group of models if said histogram includes at least a predetermined amount of large disparities, and
b) a mathematical model without a position component is chosen from said group of models if said histogram includes less than said predetermined amount of large disparities.

20. The method according to claim 17, wherein:
a) the method includes determining a tilt value for each image pair, resulting in a plurality of determined tilt values, and
b) the method includes an estimation of an overall tilt angle from said plurality of determined tilt values,
c) the method includes determining a roll value for each image pair, resulting in a plurality of determined roll values, and/or
d) the method includes an estimation of an overall roll angle from said plurality of determined roll values,
e) wherein the overall tilt angle is estimated before the overall pan angle and/or before the overall roll angle is estimated, and
f) wherein the overall pan angle is estimated before the overall roll angle is estimated.

21. The method according to claim 17, wherein a compensation table is taken into account for said rectification, wherein the compensation table includes a plurality of flow compensation values, wherein each flow compensation value indicates a flow compensation to potentially be applied to one point of each matching point pair.

22. The method according to claim 21, wherein the flow compensation is only applied to one image of each image pair, preferably the right image of each image pair, wherein the flow compensation includes the following steps:
a) tessellating the image to which the flow compensation is to be applied as a grid, preferably a 16×12 grid, thus creating a plurality of buckets, preferably 192 buckets, thus making every point of the image to which the flow compensation is applied fall into one particular bucket, wherein each bucket corresponds to one flow compensation value of the compensation table,
b) applying to each point in every bucket the flow compensation indicated by the corresponding flow compensation value.

23. The method according to claim 21, wherein the method includes determining a geometrical value for each image pair, wherein the determined geometrical value is not a pan angle and not a roll angle and not a tilt angle, wherein the determined geometrical value is preferably a translation value, resulting in a plurality of determined geometrical values, preferably translation values, and the method includes estimating an overall geometrical value, preferably an overall translation, from said plurality of determined geometrical values.

24. The method according to claim 21, wherein the method includes a procedure of creating the compensation table, wherein the procedure of creating the compensation table includes the steps:
a) defining internal parameters of the stereo camera by means of a strong calibration procedure, in particular a calibration procedure that uses a 3D grid and/or a checkerboard, and preferably
b) either finding a reference pan angle and/or a reference geometrical value, preferably a translation, by using 3D reference distances, or
c) finding the reference pan angle and/or the reference geometrical value by applying other steps .

25. A device, in particular a stereo camera system, configured to carry out a method according to claim 17.

26. A vehicle comprising a device according to claim 25.
